(19) United States
(12) Patent Application Publication
(10) Pub. No.: US 2022/0075624 A1
(43) Pub. Date: Mar. 10, 2022

(54) ALTERNATE PATH FOR BRANCH PREDICTION REDIRECT

(71) Applicant: ADVANCED MICRO DEVICES, INC., Santa Clara, CA (US)

(72) Inventors: Ashok T. VENKATACHAR, Santa Clara, CA (US); Robert COHEN, Austin, TX (US); Steven R. HAVLIR, Austin, TX (US); Aparna Chandrashekhar MANDKE, Bangalore (IN); Tzu-Wei LIN, Austin, TX (US); Bhawna NAYAK, Bangalore (IN)

(21) Appl. No.: 17/012,833

(22) Filed: Sep. 4, 2020

(51) Int. Cl. G06F 9/38; G06F 9/30; G06F 9/48; G06F 12/1027

(52) U.S. Cl. CPC G06F 9/3844; G06F 9/3861; G06F 9/30079; G06F 12/1027; G06F 9/3009; G06F 9/4843; G06F 9/30047

(57) ABSTRACT

Branch prediction circuitry predicts an outcome of a branch instruction. A pipeline circuitry processes instructions along a first path from a predicted branch of the branch instruction. The instructions along the first path are processed concurrently with processing instructions along a second path from an unpredicted branch of the branch instruction. Information representing the state of the second portion while processing the second path is stored in one or more buffers. The instructions are processed along the second path using the information stored in the buffers in response to a misprediction of the outcome of the branch instruction. In some cases, the branch prediction circuitry determines a confidence level for the predicted outcome and the instructions along the second path from the unpredicted branch are processed in response to the confidence level being below a threshold confidence.

### BACKGROUND

Processing units implement one or more pipelines to execute instructions. The pipeline typically includes (or is associated with) a branch predictor that predicts a most likely outcome of a branch instruction so that the pipeline can begin speculatively executing subsequent instructions along a path from the predicted branch before the processing unit has evaluated the branch instruction. As used herein, the term “pipeline” refers to a logical or physical grouping of hardware components that process instructions and the term “path” refers to a sequence or grouping of instructions that are being executed. The processing unit uses information in a branch prediction structure to predict the outcome of the branching instruction. For example, the processing unit can predict the outcome of conditional branch instructions that implement software constructs such as if-then-else and case statements. Examples of branch prediction structures include indirect branch predictors that redirect the flow of the program to a previously visited instruction, a return address stack that includes return addresses for subroutines executing on the processing unit, conditional branch predictors that predict the direction (taken or not taken) of a conditional branch, and a branch target buffer that includes information predicting the location, type, and target addresses of branching instructions. Some implementations of branch prediction structures use a branch history of results of branching instructions executed by processes that were previously, or are currently, executing on the processing unit as part of the prediction algorithm. For example, if a branching instruction previously directed the program flow to a first address 90% of the time and a second address 10% of the time with the current execution history, a corresponding entry in the branch prediction structure predicts that the branching instruction will direct the program flow to the first address, thereby allowing the process to speculatively execute instructions along the path beginning with the instruction at the first address without waiting for evaluation of the branching instruction.

### BRIEF DESCRIPTION OF THE DRAWINGS

The present disclosure is better understood, and its numerous features and advantages made apparent to those skilled in the art by referencing the accompanying drawings. The use of the same reference symbols in different drawings indicates similar or identical items.

FIG. 1 is a block diagram of a processing system according to some embodiments.

FIG. 2 is a block diagram of a portion of a processing system that includes a processor core according to some embodiments.

FIG. 3 is a block diagram of a first portion of a pipeline that supports concurrent execution along a main path from a predicted branch of the branch instruction and an alternate path from an unpredicted branch for branch prediction redirection according to some embodiments.

FIG. 4 is a block diagram of a second portion of the pipeline that supports execution along the main and alternate paths for branch prediction redirection according to some embodiments.

FIG. 5 is a block diagram of a first portion of a processing unit that includes a first pipeline for processing instructions along the main path from a predicted branch of the branch instruction and a second pipeline for processing instructions along an alternate path from an unpredicted branch of the branch instruction according to some embodiments.

FIG. 6 is a block diagram of a second portion of the pipeline shown in FIG. 5 according to some embodiments.

FIG. 7 is a flow diagram of a method of performing redirection using concurrent execution of instructions along a main path from a predicted branch and execution of instructions along an alternate path from an unpredicted branch according to some embodiments.

### DETAILED DESCRIPTION

In conventional speculative execution, branch instructions are evaluated after speculative execution along the predicted path has begun. Evaluation of the branching instruction indicates the actual target address of the branching instruction, which is compared to the predicted target address to determine whether the predicted outcome was correct. The results of speculative execution of instructions along the path from the predicted branch commit if the actual target address is the same as the predicted target address. However, if the predicted branch turns out to be incorrect, speculative execution along the path from the incorrectly predicted branch is suspended and the state of the processing unit is rolled back to the state at the branching instruction to begin executing along the correct path. More specifically, both the branch prediction unit and the fetch unit are rolled back to process instructions from the correct target of the branch, or the address after the branch if the branch was not taken. A key performance metric in a processing pipeline is the redirect latency, which is defined as the number of cycles needed to redirect from an incorrectly predicted path to the correct path, e.g., by rolling back the state of the processing unit to process from the correct address following the incorrectly predicted branch. A processing pipeline that processes instructions following branch prediction and up to retirement of the branching instruction includes several stages such as instructions/operation caches, decode, execute, and retire stages. Confirmation that the predicted branch is correct occurs relatively deep in the processing pipeline, which results in a relatively large redirect latency for incorrect branch predictions.

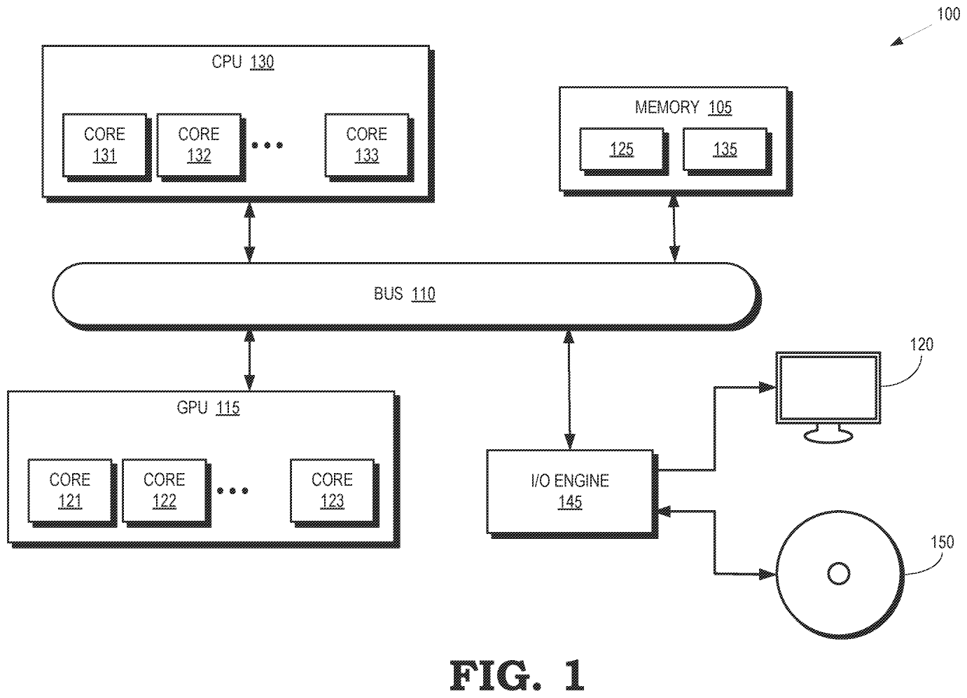

FIGS. 1-7 disclose techniques for reducing the redirect latency associated with branch prediction in a processing unit by processing an alternate path of instructions (or “alternate path” for brevity) from an unpredicted branch of the branch instruction concurrently with processing a main path of instructions (or “main path” for brevity) from the predicted branch of the branch instruction. A first portion of a pipeline processes as the main path and a second portion of the pipeline processes the alternate path. In some embodiments, the first and second portions of the pipeline are implemented using different sets of hardware. For example, the first and second portions can be implemented as separate pipelines that use portions of pipeline circuitry. In some embodiments, the first and second portions are implemented with shared hardware, e.g., a single pipeline that is used by the first and second portions to execute different instruction sets in a time multiplexed fashion. For example, different threads can be assigned to process the main path and the alternate path through a shared set of hardware circuitry and buffers. In the event of a misprediction, the thread that was allocated to the alternate path is renamed to be the new main path, as discussed below.

Results of processing the alternate path are stored in one or more redirect buffers and the buffered results are used to reconfigure the first portion of the pipeline to continue execution of the alternate path in response to an incorrect prediction for the branch instruction. In some embodiments, the second portion of the pipeline includes redirect buffers following one or more of a branch predictor, a translation lookaside buffer, an instruction cache, an operation cache, a decoder, a dispatcher, and execution stages or sections. One or more multiplexers are then used to convey the alternate results from the buffers to the first portion of the pipeline in response to an incorrect branch prediction. For example, a processor (or processor core) that implements simultaneous multithreading executes a software thread along the main path using a first logical or physical pipeline (or first hardware thread) and the alternate path using a second logical or physical pipeline (or second hardware thread). State information for the alternate path (and, in some cases, the main path) is stored in the redirect buffers. In response to detecting a misprediction, the state information for the second hardware thread that was executing the alternate path is switched to first hardware thread and the processor continues executing the alternate path using the first hardware thread. In some embodiments, state information for the second hardware thread holding the incorrect path is discarded and freed up to be used for another fork point. For example, the second hardware thread can be discarded in response to confirmation of a correct path that is used instead of the incorrect path. Including more buffers deeper in the pipeline reduces redirect latency because instructions following the misprediction can be retired sooner than other in prior implementations, although this increases the resources that are allocated to the pipeline that is processing instructions along the alternate path.

Some embodiments of the pipeline selectively process the alternate path from the unpredicted branch concurrently with the main path when there is low confidence that the branch prediction is correct. For example, the alternate path is processed in response to a confidence level returned by the branch predictor being below a threshold confidence. The branch predictor creates a fork point if there is an available hardware thread to use for executing the alternate path and synchronizes state to the alternate hardware thread. The branch predictor then treats the alternate path as if the instructions in the alternate path were part of another software thread. The alternate path is not executed if the confidence level returned by the branch predictor is above a threshold confidence. In embodiments that implement branch prediction using a tagged geometric (TAGE) length predictor, the confidence level of a branch prediction is determined by adding the weighted or normalized values of the TAGE alternate count, provider count, and bimodal count and comparing the result to a threshold. In embodiments that implement branch prediction using a Hashed Perceptron algorithm, the confidence level is determined by adding together the counts of all the table reads and comparing the result to a threshold. Some embodiments of the branch predictor receive feedback that is used to determine the branch confidence Examples of the feedback include, but are not limited to, heuristics, branch type, loop exit, and alternate indirect addresses. In some embodiments, resources used to implement pipeline that executes the alternate path are allocated to processing other instructions when the confidence level of the branch prediction for the branch instruction is above the threshold confidence. The pipeline that is used to execute the alternate path is implemented using different circuitry, either an additional translation lookaside buffer, instruction cache, operation cache, decoder, dispatcher, and the like, or by time multiplexing allocation of common circuitry shared by the main path and the alternate path, or a combination thereof.

FIG. 1 is a block diagram of a processing system 100 according to some embodiments. The processing system 100 includes or has access to a memory 105 or other storage component that is implemented using a non-transitory computer readable medium such as a dynamic random-access memory (DRAM). However, in some cases, the memory 105 is implemented using other types of memory including static random-access memory (SRAM), nonvolatile RAM, and the like. The memory 105 is referred to as an external memory since it is implemented external to the processing units implemented in the processing system 100. The processing system 100 also includes a bus 110 to support communication between entities implemented in the processing system 100, such as the memory 105. Some embodiments of the processing system 100 include other buses, bridges, switches, routers, and the like, which are not shown in FIG. 1 in the interest of clarity.

The processing system 100 includes a graphics processing unit (GPU) 115 that renders images for presentation on a display 120. For example, the GPU 115 renders objects to produce values of pixels that are provided to the display 120, which uses the pixel values to display an image that represents the rendered objects. The GPU 115 implements a plurality of processor cores 121, 122, 123 (collectively referred to herein as “the processor cores 121-123”) that execute instructions concurrently or in parallel. The number of processor cotes 121-123 implemented in the GPU 115 is a matter of design choice and some embodiments of the GPU 115 include more or fewer processor cores than shown in FIG. 1. Some embodiments of the GPU 115 are used for general purpose computing. The GPU 115 executes instructions such as program code 125 stored in the memory 105 and the GPU 115 stores information in the memory 105 such as the results of the executed instructions.

The processing system 100 also includes a central processing unit (CPU) 130 that is connected to the bus 110 and therefore communicates with the GPU 115 and the memory 105 via the bus 110. The CPU 130 implements a plurality of processor cores 131, 132, 133 (collectively referred to herein as “the processor cores 131-133”) that execute instructions concurrently or in parallel. The number of processor cores 131-133 implemented in the CPU 130 is a matter of design choice and some embodiments include more or fewer processor cores than illustrated in FIG. 1. The processor cores 131-133 execute instructions such as program code 135 stored in the memory 105 and the CPU 130 stores information in the memory 105 such as the results of the executed instructions. The CPU 130 is also able to initiate graphics processing by issuing draw calls to the GPU 115. Some embodiments of the CPU 130 implement multiple processor cores (not shown in FIG. 1 in the interest of clarity) that execute instructions concurrently or in parallel.

An input/output (I/O) engine 145 handles input or output operations associated with the display 120, as well as other elements of the processing system 100 such as keyboards, mice, printers, external disks, and the like. The I/O engine 145 is coupled to the bus 110 so that the I/O engine 145 communicates with the memory 105, the GPU 115, or the CPU 130. In the illustrated embodiment, the I/O engine 145 reads information stored on an external storage component 150, which is implemented using a non-transitory computer readable medium such as a compact disk (CD), a digital video disc (DVD), and the like. The I/O engine 145 is also able to write information to the external storage component 150, such as the results of processing by the GPU 115 or the CPU 130.

The processing system 100 implements pipeline circuitry for executing instructions in multiple stages of the pipeline. The pipeline circuitry is implemented in some embodiments of the processor cores 121-123 or the processor cores 131-133. The instructions executing in the pipeline include branch instructions that direct the program flow to different target addresses depending on an outcome of a condition for the branch instruction. As discussed herein, the pipeline circuitry includes (or is associated with) branch prediction circuitry that predicts the outcomes of branch instructions. The pipeline performs speculative execution based on the predicted outcome, e.g., the pipeline circuitry executes the predicted branch of the branch instruction along a so-called main path of instructions or “main path” for brevity. As discussed herein, the branch predictor sometimes mispredicts the outcome of the branch instruction, which requires redirection to the unpredicted branch (e.g., the unpredicted target address of the branch instruction). The processing system 100 therefore attempts to reduce the redirect latency by executing instructions along an alternate path (or “alternate path” for brevity) from an unpredicted branch of the branch instruction using a second pipeline concurrently with executing the main path from the predicted branch along the first pipeline. The first and second pipelines could be wholly or partially physically distinct from each other or, in some embodiments, the first and second pipelines could be wholly or partially logically distinct from each other. Information representing the state of the alternate path in the second pipeline is stored in one or more buffers. Execution of the alternate path is switched from the second pipeline to the first pipeline using the information stored in the one or more buffers in response to a misprediction of the outcome of the branch instruction. Some embodiments of the branch prediction circuitry determine a confidence level for the predicted outcome and the alternate path from the unpredicted branch is processed using the second pipeline in response to the confidence level being below a threshold confidence.

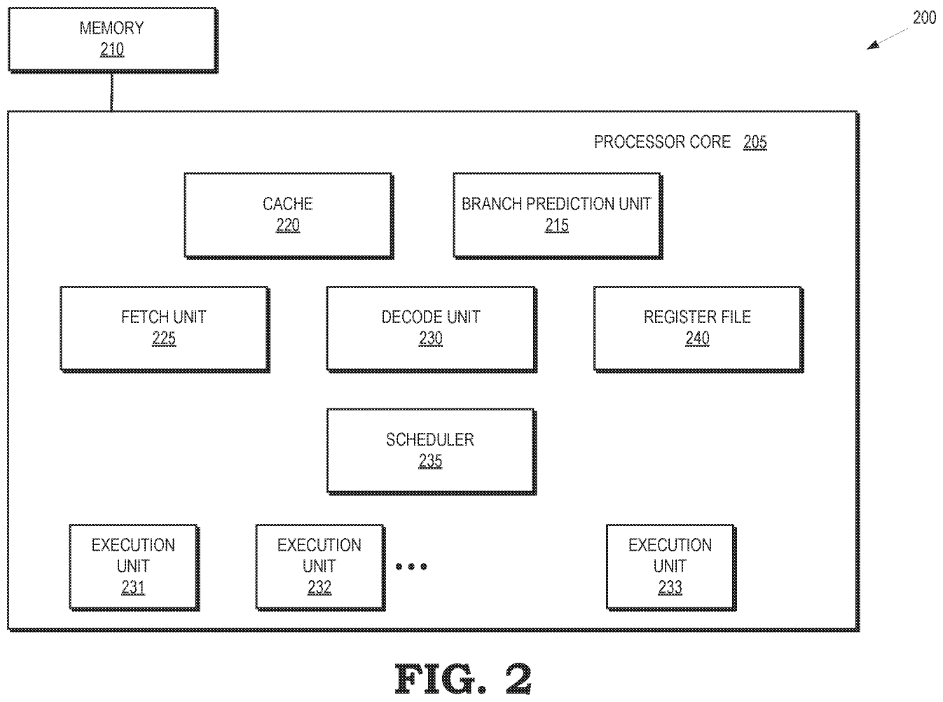

FIG. 2 is a block diagram of a portion 200 of a processing system that includes a processor core 205 according to some embodiments. The processor core 205 is used to implement some embodiments of the processor cores 121-123, 131-133 shown in FIG. 1. The portion 200 of the processing system also includes a memory 210 that is used to implement some embodiments of the memory 105 shown in FIG. 1. Some embodiments of the entities shown in FIG. 2 are implemented as circuitry including application-specific integrated circuits (ASICs), field programmable gate arrays (FPGA), other circuitry, or combinations thereof. The processor core 200 includes a branch prediction unit 215 that includes conditional branch predictor storage and conditional branch prediction logic. The conditional branch predictor storage stores addresses of locations in the memory 210 and the conditional branch prediction logic predicts outcomes of branch instructions. Copies of some of the information stored in the memory 210 are also stored in a cache 220. For example, frequently accessed instructions are stored in cache lines or cache blocks of the cache 220.

Some embodiments of the branch prediction unit 215 also include circuitry that estimates a confidence level for predicted outcomes of the branch instructions. For example, if branch prediction is performed using a tagged geometric (TAGE) length predictor, the confidence level of a branch prediction is determined by adding the weighted or normalized values of the TAGE alternate count, provider count, and bimodal count and comparing the result to a threshold. For another example, if branch prediction is performed using a Hashed Perceptron algorithm, the confidence level is determined by adding together the counts of all the table reads and comparing the result to a threshold.

A fetch unit 225 fetches information, such as instructions, from the memory 210 or the cache 220 based on addresses received from the branch prediction unit 215. The fetch unit 225 reads the bytes representing the instructions from cache 220 or memory 210 and sends the instruction to a decode unit 230. The decode unit 230 examines the instruction bytes and determines the function of the instruction. The decode unit 230 translates (i.e., decodes) the instruction to generate a series of operations that are to be performed by the processor core 205. The decoded operations are written to a scheduler 235. The scheduler 235 determines when source values for an operation are ready and sends the source values to one or more execution units 231, 232, 233, which are collectively referred to herein as “the execution units 231-233,” to perform the operation. The result is written back to a register file 240.

Some embodiments of the branch prediction unit 215 include entries associated with the branch instructions that have been previously executed by the current process or a process that previously executed on the processor core 205. Branch prediction information stored in each entry of the branch prediction unit 215 indicates a likelihood that the branch instruction directs the program flow to an address of an instruction. The entries in the branch prediction unit 215 are accessed based on an address of the corresponding branch instruction. For example, the values of the bits (or a subset thereof) that represent a physical address, a virtual address, or a cache line address of the branch instruction are used as an index into the branch prediction unit 215. For another example, hashed values of the bits (or a subset thereof) are used as the index into the branch prediction unit 215. Examples of branch prediction structures include an indirect branch predictor, a return address stack, a branch target buffer, a conditional branch predictor, a branch history, or any other predictor structure that is used to store the branch prediction information.

The scheduler 235 schedules execution of the instructions by the processor core 205. Some embodiments of the scheduler 235 perform speculative execution of instructions following a branch instruction that redirects the program flow to an instruction at an address in the memory 210 (or related cache 220) that is indicated by the branch instruction. Branch instructions include conditional branch instructions that redirect the program flow to an address dependent upon whether a condition is true or false. For example, conditional branch instructions are used to implement software constructs such as if-then-else and case statements. Branch instructions also include unconditional branch instructions that always redirect the program flow to an address indicated by the instruction. For example, a jump (JMP) instruction always jumps to an address indicated by the instruction. In some cases, the target address is provided in a register or memory location so the target can be different each time the branch is executed. Such branches are called indirect branches. The portion of the program flow including instructions that are executed beginning at the address in the memory 210 predicted by the branch predictor 215 is referred to as a “main” path of the speculative execution. The scheduler 235 schedules instructions for execution along the main path by the processing pipeline implemented in the processor core 200.

The scheduler 235 also schedules instructions beginning at an unpredicted address such as an alternate target address at another location in the memory 210 or the address subsequent to the branch instruction. The portion of the program flow including instructions that are executed beginning at the unpredicted address in the memory 210 is referred to as an “alternate” path of the speculative execution. In some embodiments, the scheduler 235 selectively schedules the alternate path for concurrent execution on a different pipeline based on a confidence level for the prediction. For example, the scheduler 235 schedules the alternate path for processing in response to the confidence level being below a threshold confidence level. The scheduler 235 schedules the main path and the alternate path for concurrent execution, e.g., using separate pipelines (or portions thereof) implemented by the execution units 231-233. Some embodiments of the scheduler 235 schedule the main and alternate paths for concurrent execution on different circuitry (e.g., pipelines implemented in different execution units 231-233), using time multiplexed resources of shared circuitry such as one of the execution units 231-233, or a combination thereof.

A first pipeline continues processing the main path as long as a misprediction is not detected. If no misprediction is detected during processing, the instructions on the main path are retired. However, the state of the alternate path is stored in one or more buffers during processing of the alternate path along a second pipeline. If a misprediction is detected, the state information stored in the buffers is used to switch the alternate path from the second pipeline to the first pipeline so that the alternate path becomes the new main path. As discussed herein, the buffers are implemented at locations along the second pipeline. Switching execution of the alternate path from the second pipeline to the first pipeline in response to a misprediction therefore allows a redirection to be performed with less redirection latency than would be required if processing along alternate path from the unpredicted branch is only initiated after a misprediction. The portion 200 of the processing system therefore trades off the costs of additional hardware and resources to support concurrent execution of the main and alternate paths with the benefits of reduced redirection latency. Selectively performing concurrent execution of the main and alternate paths for branch predictions having low confidence levels increases the likelihood that the trade-off between costs and benefits is favorable because branch predictions that have low confidence levels are more likely to be mispredicted.

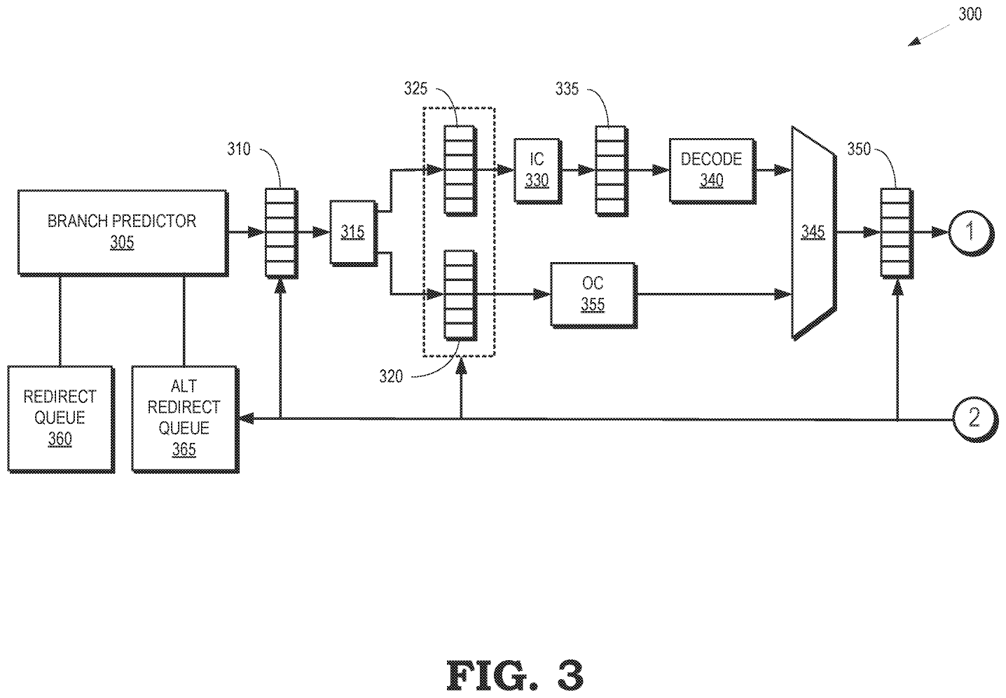

FIG. 3 is a block diagram of a first portion 300 of a pipeline that supports concurrent execution of a main path and an alternate path for branch prediction redirection according to some embodiments. The first portion 300 of the pipeline is implemented in some embodiments of the processing system 100 shown in FIG. 1 and the portion 200 of the processing system shown in FIG. 2. The first portion 300 includes a branch predictor 305 that predicts outcomes of branch instructions that are being processed in the first portion 300 of the pipeline. Some embodiments of the branch predictor 305 also generate confidence levels for the predicted outcomes. For example, if the branch predictor 305 implements branch prediction using a tagged geometric (TAGE) length predictor, the branch predictor 305 determines the confidence level of a branch prediction by adding the weighted or normalized values of the TAGE alternate count, provider count, and bimodal count and comparing the result to a threshold. For another example, if the branch predictor 305 implements branch prediction using a Hashed Perceptron algorithm, the branch predictor 305 determines the confidence level by adding together the counts of all the table reads and comparing the result to a threshold.

The portion 300 of the pipeline concurrently processes a main path from the predicted branch of the branch instruction and an alternate path from an unpredicted branch of the branch instruction. As discussed herein, some embodiments of the portion 300 selectively processes the alternate path based on a comparison of the confidence level for the outcome and a confidence threshold. The alternate path is processed if the confidence level is low (e.g., below the confidence threshold) and is not processed if the confidence level in the predicted outcome is high (e.g., above the confidence threshold). State information for the main path and the alternate path are provided to a redirect buffer 310.

A controller 315 accesses instructions from the redirect buffer 310 and selectively directs the instructions along the main path or the alternate path. Instructions that are directed along the main path are conveyed to a buffer 320 and instructions that are directed along the alternate path are conveyed to a buffer 325.

An instruction cache (IC) 330 accesses instructions from the buffer 325 and the instructions are held in the instruction cache 330 until the data required by the instructions becomes available. The instruction cache 330 is used to hold instructions along the main path and instructions along the alternate path during concurrent processing along the main path and the alternate path. In some embodiments, the instruction cache 330 is implemented as multiple caches or a partitioned cache so that different hardware components are allocated to store instructions for the main path and instructions for the alternate path. In some embodiments, the instruction cache 330 is a common resource that is shared by the main path and the alternate path, e.g., to support time multiplexing of the resources of the pipeline. State information that indicates the state of the portion 300 of the pipeline that is executing the alternate path after the instruction cache 330 is stored in one or more buffers 335.

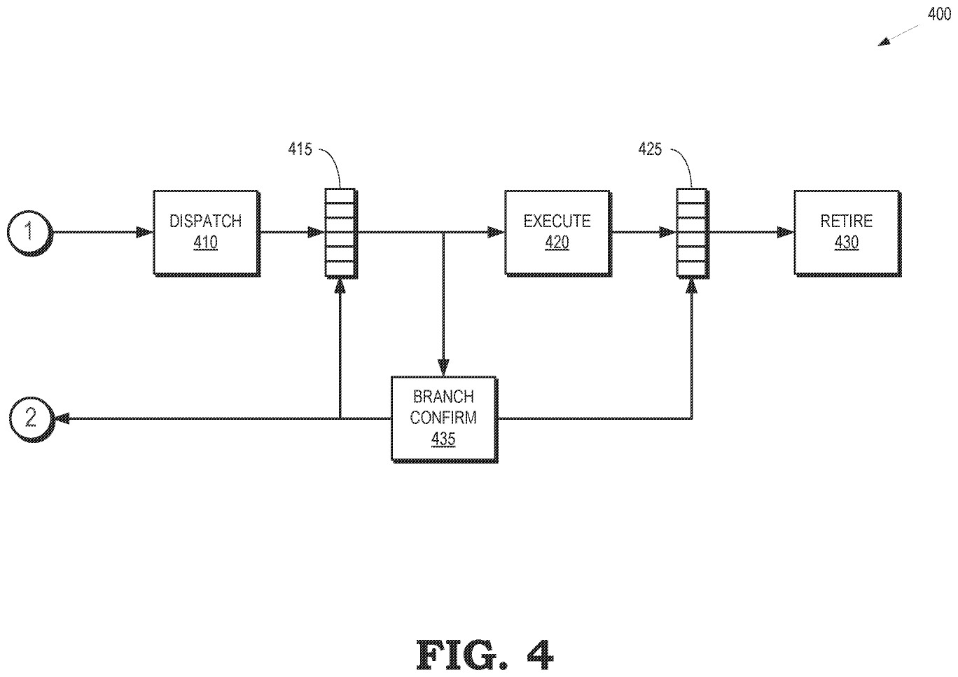

Instructions that are ready for decoding are pushed out of the instruction cache 330 to a decoder 340 (via the buffer 335) and the decoder 340 performs decoding of the instructions. The decoder 340 is used to decode instructions along the main path and the alternate path using different hardware instances of the decoder 340 or time multiplexing shared resources of a common instance of the decoder 340. The decoder 340 provides the decoded instructions to a multiplexer 345 that selectively provides the decoded instructions to one or more buffers 350 that are connected to the node 1, which is connected to the same node 1 shown in a second portion 400 of the pipeline shown in FIG. 4.

In some embodiments, the buffers 350 function as a partition between front end work performed in the first portion 300 and the backend work performed in the second portion 400 shown in FIG. 4. The buffers 350 store state information and work performed in the first portion 300. The state information indicates the state of the portion 300 of the pipeline that is executing the alternate path after decoding of the instructions is stored in the buffers 350. In response to the branch that is the fork point being evaluated, e.g., in the branch confirmation block 435 shown in FIG. 4, the path that is flushed from the buffers 350 and the path that is maintained or established as the main path are selected.

The portion 300 also includes an operation cache (OC) 355 that caches previously decoded instructions, which are held in the operation cache 355 until they are provided to the multiplexer 345. The operation cache 355 is used to cache previously decoded instructions along the main path and the alternate path. In some embodiments, the operation cache 355 is implemented as multiple caches or a partitioned cache so that different hardware components are allocated to cache previously decoded instructions along the main path and the alternate path. In some embodiments, the operation cache 355 is a common resource that is shared by the main path and the alternate path, e.g., to support time multiplexing of the resources of the pipeline.

The illustrated embodiment, the portion 300 includes a redirect queue 360 that holds requests for redirection that are generated in response to a misprediction of the outcome of the branch instruction by the branch predictor 305. The portion 300 also includes an alternate redirect queue 365 that holds requests for redirection from the main path to the alternate path in response to a misprediction of the outcome of the branch instruction. The redirect requests are received via the node 2 and the corresponding node 2 in the portion 400 of the pipeline shown in FIG. 4. Some embodiments of the redirect queue 360 and the alternate redirect queue 365 store information representing the history of the operations performed in the pipeline and path prediction information that is used for rollback of the pipeline state in response to detecting a misprediction.

FIG. 4 is a block diagram of a second portion 400 of the pipeline that supports concurrent execution along the main path and the alternate path for branch prediction redirection according to some embodiments. The second portion 400 of the pipeline is implemented in some embodiments of the processing system 100 shown in FIG. 1 and the portion 200 of the processing system shown in FIG. 2. The second portion 400 shown in FIG. 4 communicates with the first portion 300 shown in FIG. 3 via the nodes 1 and 2, which connect to the corresponding nodes 1 and 2 in the first portion shown in FIG. 3.

Decoded instructions are received at the second portion 400 via the node 1. The decoded instructions are then provided to a dispatch module 410 that dispatches the decoded instructions for execution in an execution module 420 via one or more buffers 415. State information that indicates the state of the portion 400 of the pipeline that is executing the alternate path after dispatch of the instructions is stored in one or more buffers 415 and state information that indicates the state after execution is stored in one or more buffers 425. In response to the execution module 420 completing execution of the instructions, the instructions are provided to retire module 430 via one or more buffers 425 to retire the instructions and commit the results to memory.

In the illustrated embodiment, the dispatch module 410, the execution module 420, and the retire module 430 are used to implement the pipeline that execute instructions concurrently along the main path and the alternate path. In some embodiments, the modules are implemented using different hardware components that are separately allocated to execute instructions along the main path and the alternate path. In some embodiments, each of the modules is a common resource that is shared by the main path and the alternate path, e.g., to support time multiplexing of the resources of the pipeline.

Branch confirmation circuitry 435 determines whether the branch predictor (e.g., the branch predictor 305 shown in FIG. 3) correctly predicted the outcome of the branch instruction. If so, the results of processing the predicted branch along the main path are retired. If not, the branch confirmation circuitry 435 generates a redirect request to switch the alternate path to the main path. Switching paths uses state information stored in one or more of the buffers 310, 320, 325, 335, 350 shown in FIG. 3 or the buffers 415, 425 shown in FIG. 4. For example, state information stored in the buffer 415 can be used to reconfigure the portion of the execution module 420 that was previously allocated to the main path to correspond to the state of the pipeline that was executing the alternate path prior to the execution module 420. Processing along the reconfigured main path then resumes so that the redirection from the mispredicted main path to the unpredicted alternate path is performed with lower redirect latency that would be required if the redirection required beginning processing along the on predicted alternate path at the branch predictor 305 shown in FIG. 3.

Although the illustrated embodiment of the pipeline includes the buffers 310, 320, 325, 335, 350 shown in FIG. 3 or the buffers 415, 425 shown in FIG. 4, some embodiments of the pipeline include more or fewer buffers implemented at the same or different locations within the pipeline. The number or location of the buffers is determined based on a trade-off between increased cost and decreased redirect latency. For example, a lower cost is incurred for a relatively higher redirect latency by implementing the buffers 310, 320, 325, 335, 350 and omitting the buffers 415, 425 from the pipeline.

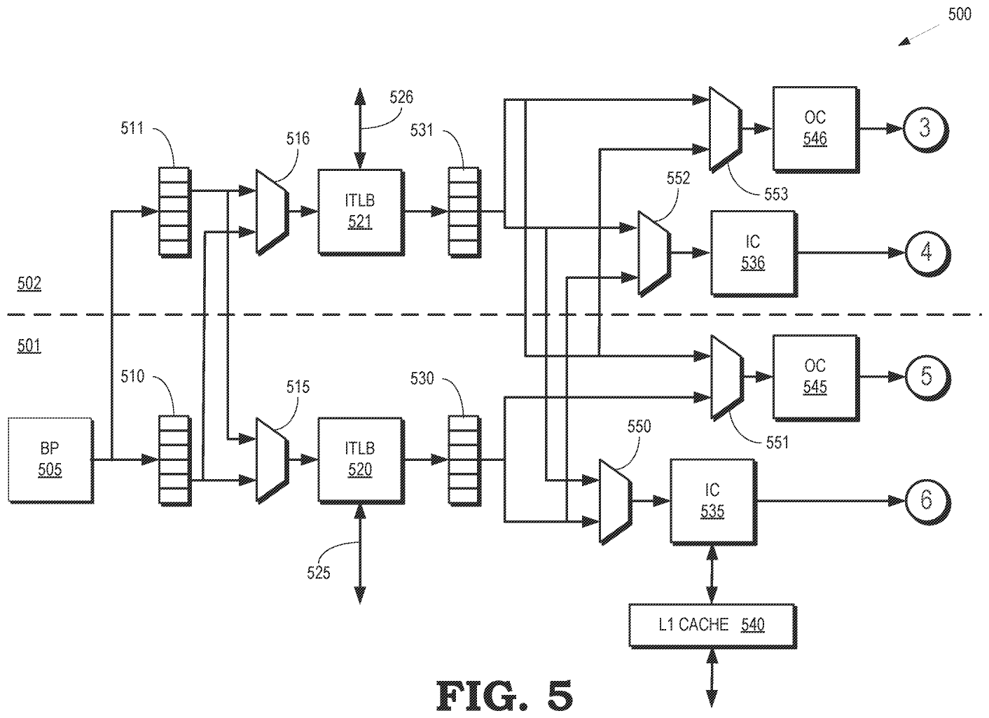

FIG. 5 is a block diagram of a first portion 500 of a processing unit that includes a first pipeline 501 for processing instructions along the main path from a predicted branch of the branch instruction and a second pipeline 502 for processing instructions along an alternate path from an unpredicted branch of the branch instruction according to some embodiments. The first portion 500 of the processing unit is implemented in some embodiments of the processing system 100 shown in FIG. 1 and the portion 200 of the processing system shown in FIG. 2. The first portion 500 includes a branch predictor 505 that predicts outcomes of branch instructions that are being processed in the first portion 500 of the pipeline. Some embodiments of the branch predictor 505 also generate confidence levels for the predicted outcomes, as discussed herein. State information representing processing of the main path from the predicted branch using the first pipeline 501 is stored in a buffer 530 and state information representing processing of the alternate path from the unpredicted branch using the second pipeline 502 is stored in a buffer 511.

The first portion 500 of the pipeline concurrently processes the main path using first pipeline 501 and the alternate path using second pipeline 502. As discussed herein, some embodiments of the portion 500 selectively process the alternate path based on a comparison of the confidence level for the outcome and a confidence threshold. The second pipeline 502 processes the alternate path if the confidence level is low (e.g., below the confidence threshold) and does not process the alternate path 502 if the confidence level in the predicted outcome is high (e.g., above the confidence threshold). The hardware used to implement the second pipeline 502 can be used to perform other operations if the second pipeline 502 is not used to process alternate path from the unpredicted branch concurrently with processing the main path from the predicted branch on the first pipeline 501.

In the illustrated embodiment, the first portion 500 includes multiplexers 515, 516 that allow state information to be exchanged between the first pipeline 501 and the second pipeline 502. For example, state information from the buffer 510 can be multiplexed into the second pipeline 502 via the multiplexer 516 and state information from the buffer 511 can be multiplexed into the first pipeline 501 via the multiplexer 515. The multiplexer 515 is therefore used to reconfigure some embodiments of the first pipeline 501 using the state information stored in the buffer 511 in response to a misprediction, e.g., to switch the state associated with processing the alternate path into the first pipeline 501. In some embodiments, the multiplexer 516 is used to multiplex information from the branch predictor 505 into the second pipeline 502 so that the resources of the second pipeline 502 are available to process other instructions in the event that the second pipeline 502 is not needed to process an unpredicted branch.

Translation lookaside buffers (I-TLB) 520, 521 are used to store addresses that are frequently used by the instructions that are processed along the first pipeline 501 and the second pipeline 502, respectively. The translation lookaside buffers 520, 521 transmit requests for address translations of virtual addresses received by the translation lookaside buffers 520, 521 and receive responses including the requested translations of virtual addresses to physical addresses, as indicated by the arrows 525, 526. State information representing processing of the main path from the predicted branch along the first pipeline 501 following operation of the translation lookaside buffer 520 is stored in a buffer 510 and state information representing processing of the alternate path from the unpredicted branch along the second pipeline 502 following operation of the translation lookaside buffer 521 is stored in a buffer 511.

The first pipeline 501 and the second pipeline 502 include corresponding instruction caches (IC) 535, 536 that access state information including address translations from buffers 530, 531. The instructions are held in the instruction caches 535, 536 until the data required by the instructions becomes available. The instruction cache 535 requests information from the L1 cache 540. The instruction cache 536 in the second pipeline 502 is also able to request information from the L1 cache 540, although this pathway is not indicated by arrows in the interest of clarity. The first pipeline 501 and the second pipeline 502 also include corresponding operation caches (OC) 545, 546 that cache previously decoded instructions, which are held in the operation caches 545, 546.

Information is exchanged between the first pipeline 501 and the second pipeline 502 using circuitry such as multiplexers. In the illustrated embodiment, the first pipeline 501 includes multiplexers 550, 551 that multiplex state information from the buffer 531 to the instruction cache 535 or the operation cache 545 in the first pipeline 501. The multiplexers 550, 551 are therefore used to reconfigure some embodiments of the first pipeline 501 using the state information stored in the buffer 531 in response to a misprediction, e.g., to switch the state associated with processing the alternate path from the unpredicted branch into the first pipeline 501. In the illustrated embodiment, the second pipeline 502 includes multiplexers 552, 553 that multiplex state information from the buffer 530 to the instruction cache 536 or the operation cache 546 in the second pipeline 502.

In the illustrated embodiment, the operation cache 546 communicates with subsequent stages of the pipeline via the node 3. The instruction cache 536 communicates with the subsequent stages of the pipeline via the node 4. The operation cache 545 communicates with subsequent stages of the pipeline via the node 5. The instruction cache 535 communicates with subsequent stages of the pipeline via the node 6.

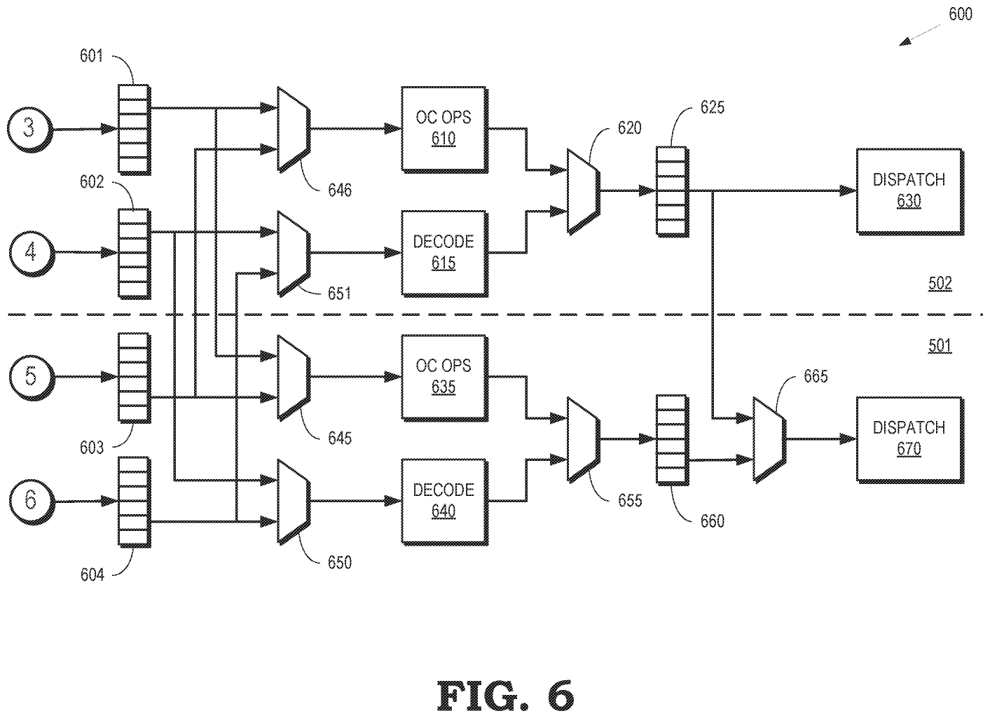

FIG. 6 is a block diagram of a second portion 600 of the pipeline that includes the first pipeline 501 and the second pipeline 502 for processing main and alternate paths from predicted and unpredicted branches of a branch instruction according to some embodiments. The second portion 600 of the pipeline is implemented in some embodiments of the processing system 100 shown in FIG. 1 and the portion 200 of the processing system shown in FIG. 2. The second portion 600 is linked to the first portion 500 shown in FIG. 5 via the nodes 3-6. In the illustrated embodiment, the buffer 601 receives and stores state information representing the state of the pipeline subsequent to the operation cache 546 shown in FIG. 5 via the node 3, the buffer 602 receives and stores state information representing the state of the pipeline subsequent to the instruction cache 536 shown in FIG. 5 via the node 4, the buffer 603 receives and stores state information representing the state of the pipeline subsequent to the operation cache 545 shown in FIG. 5 via the node 5, and the buffer 604 receives and stores state information representing the state of the pipeline subsequent to the instruction cache 535 via the node 6.

The second pipeline 502 includes an operation cache 610 and a decoder 615. In the illustrated embodiment, previously decoded operations are conveyed from the operation cache 546 to the operation cache 610 via the node 3. Instructions that have not yet been decoded are conveyed from the instruction cache 536 to the decoder 615 via the node 4. The decoder 615 decodes the received instruction and provides the decoded instruction to a multiplexer 620, which selectively provides the decoded instruction from the decoder 615 or the decoded instruction from the operation cache 610 to the buffer 625. A buffer 625 stores state information representing the state of the pipeline subsequent to the multiplexer 620, e.g., state information associated with the decoded instructions received from the operation cache 610 or the decoder 615. Decoded instructions and associated state information are provided from the buffer 625 to dispatch circuitry 630 for dispatching the decoded instructions for execution. The first pipeline 501 includes an operation cache 635 and a decoder 640.

The first pipeline 501 and the second pipeline 500 and to exchange information via circuitry such as multiplexers. In the illustrated embodiment, the first pipeline 501 includes multiplexers 645, 650 that selectively multiplex information to the operation cache 635 or the decoder 640 from either the buffers 603, 604 in the first pipeline 501 or more of the buffers 601, 602 in the second pipeline 502. In some embodiments, the multiplexers 645, 650 multiplex information from the buffers 601, 602 in the second pipeline 502 to the operation cache 635 or the decoder 640 in response to a misprediction, as discussed herein. In the illustrated embodiment, the second pipeline 502 includes multiplexers 646, 651 that selectively multiplex information to the operation cache 610 or the decoder 615 from either the buffers 603, 604 in the first pipeline 501 or more of the buffers 601, 602 in the second pipeline 502.

A multiplexer 655 selectively provides the decoded instruction from the decoder 640 or the decoded instruction from the operation cache 635 to the buffer 660, which stores state information representing the state of the pipeline subsequent to the multiplexer 655, e.g., state information associated with the decoded instructions received from the operation cache 635 or the decoder 640. Decoded instructions and associated state information are provided from the buffer 660 to a multiplexer 665 that selectively provides information from the buffer 660 or the buffer 625 in the second pipeline 502 to dispatch circuitry 670 for dispatching the decoded instructions for execution. In some embodiments, the multiplexer 665 provides information from the buffer 625 in the second pipeline 502 to the dispatch circuitry 670 in response to a misprediction, as discussed herein.

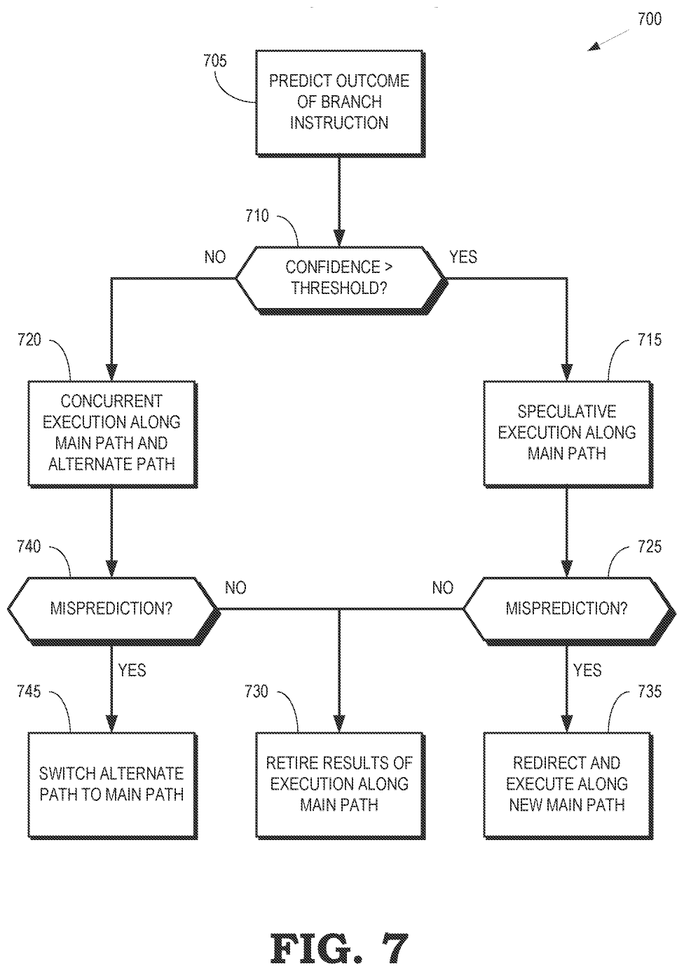

FIG. 7 is a flow diagram of a method 700 of performing redirection using concurrent execution along a main path from a predicted branch and along an alternate path from an unpredicted branch according to some embodiments. The method 700 is implemented in some embodiments of the processing system 100 shown in FIG. 1, the pipeline shown in FIGS. 3 and 4, and the pipeline shown in FIGS. 5 and 6.

At block 705, a branch predictor predicts an outcome of a branch instruction. The branch predictor also predicts a confidence level for the prediction. In some embodiments, the confidence level of a branch prediction is determined by adding the weighted or normalized values of a TAGE alternate count, provider count, and bimodal count and comparing the result to a threshold if the branch predictor performs branch prediction using TAGE length predictor. If the branch predictor performs branch prediction using a Hashed Perceptron algorithm, the confidence level can be determined by adding together the counts of all the table reads and comparing the result to a threshold. Some embodiments of the branch predictor receive feedback that is used to determine the branch confidence. Examples of the feedback include, but are not limited to, heuristics, branch type, loop exit, and alternate indirect addresses.

At decision block 710, the confidence level is compared to a threshold confidence. If the confidence level is greater than the threshold, indicating a relatively high degree of confidence in the prediction, the method 700 flows to the block 715. If the confidence level is less than or equal to the threshold, indicating a relatively low degree of confidence in the prediction, the method 700 flows to the block 720.

At block 715, the pipeline begins speculative execution along a main path. The pipeline does not perform concurrent execution of instructions along an alternate path from an unpredicted branch along the alternate path because of the relatively high degree of confidence in the prediction. At decision block 725, the pipeline determines whether a misprediction is detected during execution along the main path. If no misprediction is detected, the method 700 flows to the block 730 and the results of execution along the main path are retired. If a misprediction is detected, the method 700 flows to block 735 and a redirection request is issued. In response to the redirection request, the pipeline is flushed and the state of the pipeline is rolled back. Execution of instructions along a path from the previously unpredicted branch target or path begins.

At block 720, the pipeline begins speculative execution of instructions along the main path from the predicted branch and concurrent execution of instructions along the alternate path from the unpredicted branch. At decision block 740, the pipeline determines whether a misprediction is detected during execution along the main path. If no misprediction is detected, the method 700 flows to the block 730 and the results of execution along the main path are retired. The results of concurrent execution of the alternate path are discarded. If a misprediction is detected during execution of the main path, the method 700 flows to block 745. At block 745, the current main path post-branch is discarded and state information stored in buffers associated with the alternate path is used to switch the alternate path to the main path. Execution of what was the alternate branch path now continues as the new main path.

In some embodiments, the apparatus and techniques described above are implemented in a system including one or more integrated circuit (IC) devices (also referred to as integrated circuit packages or microchips), such as the pipeline described above with reference to FIGS. 1-7. Electronic design automation (EDA) and computer aided design (CAD) software tools are used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device could be stored in and accessed from the same computer readable storage medium or a different computer readable storage medium.

A computer readable storage medium includes any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. Some embodiments of the computer readable storage medium are embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above are implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium is in source code, assembly language code, object code, or other instruction format that is interpreted or otherwise executable by one or more processors.

Note that not all of the activities or elements described above in the general description are required, that a portion of a specific activity or device are not required, and that one or more further activities are performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that cause any benefit, advantage, or solution to occur or become more pronounced are not to be construed as a critical, required, or essential feature of any or all the claims. Moreover, the particular embodiments disclosed above are illustrative only, as the disclosed subject matter could be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above could be altered or modified and all such variations are considered within the scope of the disclosed subject matter. Accordingly, the protection sought herein is as set forth in the claims below.

1. An apparatus comprising:
branch prediction circuitry configured to predict an outcome of a branch instruction;
a first portion of a pipeline circuitry configured to process instructions along a first path from a predicted branch of the branch instruction, wherein processing the instructions along the first path is time multiplexed with processing instructions along a second path from an unpredicted branch of the branch instruction; and
a plurality of redirect buffers configured to store information representing at least one state of the first portion of the pipeline circuitry along the second path, and wherein the pipeline circuitry is configured to process instructions in a second portion of the pipeline circuitry using the information stored in the plurality of redirect buffers in response to a misprediction of the outcome of the branch instruction.

2. (canceled)

3. The apparatus of claim 1, wherein at least one redirect buffer of the plurality redirect buffers is configured to store state information representing the state of the first portion of the pipeline circuitry subsequent to processing by at least one of the branch prediction circuitry, a translation lookaside buffer, an instruction cache, an operation cache, a decoder, a dispatcher, and an execution section of the pipeline circuitry.

4. The apparatus of claim 1, further comprising:
at least one multiplexer configured to convey information stored in the at least one redirect buffer from the second path of the first portion of the pipeline circuitry to the first path of the first portion of the pipeline circuitry in response to the misprediction.

5. The apparatus of claim 4, wherein the pipeline circuitry comprises at least one processor core configured to execute a thread associated with the predicted branch along the first path and to execute the thread associated with the unpredicted branch along the second path based on information stored in the at least one redirect buffer.

6. The apparatus of claim 5, wherein the pipeline circuitry is configured to switch the thread from the second path to the first path in response to the misprediction.

7. The apparatus of claim 6, wherein the pipeline circuitry is configured to discard the thread executing on the second path in response to confirmation of the misprediction.

8. The apparatus of claim 1, wherein the branch prediction circuitry is configured to determine a confidence level for the predicted outcome, and wherein the second path of the pipeline circuitry is configured to process the unpredicted branch in response to the confidence level being below a threshold confidence.

9. The apparatus of claim 8, wherein the branch prediction circuitry is configured to create a fork point for the second path and synchronize a thread on the first path and the second path in response to the confidence level being below the threshold confidence.

10. A method comprising:
predicting an outcome of a branch instruction;
processing, in a portion of a pipeline circuitry, instructions along a first path from a predicted branch of the branch instruction, wherein processing the instructions along the first path is time multiplexed with processing instructions along a second path from an unpredicted branch of the branch instruction;
storing, in a plurality of redirect buffers, information representing at least one state of the second path of the pipeline circuitry; and
reconfiguring the portion of the pipeline circuitry to continue execution using the information stored in the plurality of redirect buffers in response to a misprediction of the outcome of the branch instruction.

11. (canceled)

12. The method of claim 10, wherein storing the information representing the at least one state of the second path of the portion of the pipeline circuitry comprises storing the state information representing the state of the second path subsequent to processing the second path by at least one of a branch predictor, a translation lookaside buffer, an instruction cache, an operation cache, a decoder, a dispatcher, and an execution section of the pipeline circuitry.

13. The method of claim 10, wherein reconfiguring the portion of the pipeline circuitry comprises conveying information stored in at least one redirect buffer of the plurality of redirect buffers to the first path in response to the misprediction.

14. The method of claim 13, wherein processing instructions along the first path from the predicted branch comprises executing a thread associated with the predicted branch, and wherein processing instructions along the second path from the unpredicted branch comprises executing a thread associated with the unpredicted branch based on information stored in the at least one redirect buffer.

15. The method of claim 14, wherein reconfiguring the portion of the pipeline circuitry comprises switching the thread from the second path to the first path in response to the misprediction.

16. The method of claim 15, further comprising:
discarding the thread executing on the second path in response to confirmation of a correct prediction.

17. The method of claim 10, further comprising:
determining a confidence level for the predicted outcome; and
processing instructions along the second path from the unpredicted branch in response to the confidence level being below a threshold confidence.

18. The method of claim 17, further comprising:
creating a fork point for the second path; and
synchronizing a thread on the first path and the second path in response to the confidence level being below the threshold confidence.

19. A method comprising:
predicting an outcome of a branch instruction and a confidence level for the prediction;
processing, in a portion of a pipeline circuitry, instructions along a first path from a predicted branch of the branch instruction;
selectively processing, based on the confidence level, instructions along a second path from an unpredicted branch of the branch instruction using the portion of the pipeline circuitry wherein processing the instructions along the second path is time multiplexed with processing instructions along the first path; and
switching the second path to the first path using information stored in a plurality of redirect buffers in response to a misprediction of the outcome of the branch instruction.

20. The method of claim 19, wherein selectively processing the unpredicted branch comprises processing the instructions along the second path from the unpredicted branch in response to the confidence level being below a threshold confidence.

21. The method of claim 19, wherein selectively processing the instructions along the second path from the unpredicted branch comprises processing instructions along the first path from the predicted branch concurrently with processing the instructions along the second path from the unpredicted branch using at least one of different circuitry and time multiplexed resources of shared circuitry.
